(19) United States
(12) Patent Application Publication
(10) Pub. No.: US 2008/0197083 A1
(43) Pub. Date: Aug. 21, 2008

(54) Method and Installation For Treating Community Effluents

(75) Inventors: Bernard Raveneau-Champion, Puteaux (FR); Michel Reveniault, Coubert (FR)

Correspondence Address: CONNOLLY BOVE LODGE & HUTZ LLP, 1875 EYE STREET, N.W., SUITE 1100, WASHINGTON, DC, 20036, US

(73) Assignee: SUEZ ENVIRONNEMENT, Paris (FR)

(21) Appl. No.: 11/916,143

(22) PCT Filed: May 23, 2006
(86) PCT No.: PCT/FR06/01174

§ 371 Date: Mar. 31, 2008

(30) Foreign Application Priority Data
Jun. 3, 2005 (FR) 0505664

(51) Int. Cl. C02F 1/00; C02F 7/00

(52) U.S. Cl. 210/747; 210/170.03

(57) ABSTRACT

The invention concerns a method for treating effluents of communities equipped with a wastewater system capable of collecting rain or infiltration water, such that the flow rate of effluents to be treated by a treatment station may greatly vary between a dry weather period and a rainy weather period, whereby is provided a purification plant (1) of capacity substantially adapted to effluent flow rate in dry weather (Qs); upstream of the treatment plant, is provided a filter bed (12) with grown plants for stocking without fermenting, a polluted hydric excess, and for prior treatment; effluent excess (Qp) caused by rain or a storm is directed onto the filter bed (12) with grown plants; the water in stored in the filter bed (12) with grown plants is gradually evacuated to be sent to the treatment plant (1) located downstream.

The invention relates to an effluent treatment process for communities equipped with a drainage system capable of collecting rainwater or infiltration water, so that the flow rates of effluents to be treated by a treatment facility may vary greatly between a dry weather period and a rainy period.

The term “community” denotes for example a commune, a built-up area, a syndicate or an industry.

Communities in the suburban or rural sectors are generally provided with quite an extensive collective drainage system, which drains large quantities of surface water. Thus, it is generally found that wastewater collected in dry weather consists of 50 to 60% of clear infiltration surface water.

Moreover, owing to the fact that communities are mindful of limiting their investments or because their drainage system was constructed a very long time ago, this system also collects a great deal of rainwater or atmospheric water.

Now, the size of treatment facilities, whether of the extensive type (for example with a bacterial bed followed by a reed filter bed) or of the intensive type (free-culture activated sludge), largely takes the hydraulic factors into account, thereby requiring oversized facilities, increasing the investment cost of installations and monopolizing relatively large areas of communal land. Examples of extensive-type treatment facilities are provided by FR 2 782 508 and FR 2 858 316.

Sudden increases in flow, caused by rain, therefore result in installations being designed to cater for large flows of water to be treated, something which rarely occurs in normal service.

It is conceivable to store the excess polluted water, caused by a storm or torrential rain, but the excess has to be treated within 24 hours in order to limit fermentation, which is a source of foul smells and the cause of degradation in the quality of the purification treatment.

Finally, the need to obtain a relatively constant treatment quality, even in the event of heavy rain, has a substantial influence on the dimensions of the treatment facility.

The object of the invention is above all to provide an effluent treatment process for communities which makes it possible to “smooth out” the flow peaks due to rainfall, especially stormwater, and to obtain a relatively constant treatment quality from the treatment facility. It is desirable for the footprint of installations to be as small as possible.

According to the invention, the community effluent treatment process is characterized in that:
a treatment facility is provided with a capacity essentially adapted to the dry weather effluent flow rate;
provided upstream of the treatment facility is a plant filter bed suitable for storing, without fermentation, an excess of polluted water and in carrying out a pretreatment;
the excess flow of effluents caused by rainwater or stormwater is directed onto the plant filter bed; and
the water stored in the plant filter bed is drained off over several days so as to send it to the treatment facility located downstream.

Advantageously, the plants are reeds.

Preferably, the stored water is drained off, especially by pumping, over a week or longer, thereby resulting in a minimal impact on the size of the treatment facilities located downstream. This treatment facility can be designed for a dry weather effluent flow.

Although the time the wastewater is stored in the plant filter bed is longer than a few days, no fermentation giving off foul-smelling pollutants is observed. Aerated by the plants, particularly reeds, and their rhizomes, the wastewater does not ferment in the filter bed.

By progressively draining off the wastewater stored in the plant filter bed it is possible to avoid oversizing the treatment facility, which is reflected in a smaller footprint and a lower investment cost.

The storage capacity is chosen by the community. The period for removing the wastewater from the reed plant bed must be followed by a rest period of at least one week, needed to avoid stratification of heterogeneous sludge layers.

The storage tank may be fed over a period of at least two weeks, the plants having to be capable of withstanding prolonged immersion.

Advantageously, a bypass is provided, especially by closing of an automatic valve, for directing the total effluent flow to the treatment facility when the storage capacity of the plant bed filter is reached or when the feed period is over.

Advantageously, an automatic program controls the valve for the intake of effluents into the reed bed on the basis of the measurement of the liquid level in the reed filter and, in particular by means of an ultrasonic sensor on the basis of a programmed clock.

The automatic program may also control the level of solids (filter mass plus sludge produced) and monitor it over a long period (several years) in order to indicate at what moment a flushing operation has to be carried out.

The invention also relates to an effluent treatment installation for communities equipped with a drainage system capable of collecting rainwater or infiltration water, for implementing the process defined above. Such an installation is characterized in that it comprises:
a treatment facility of capacity adapted essentially to the dry weather effluent flow rate;
upstream of the treatment facility, a plant filter bed suitable for storing, without fermentation, an excess flow of polluted water and in carrying out a pretreatment;
means for directing the excess flow of effluents caused by rainwater or stormwater onto the plant filter bed; and
means for draining off, over several days, in particular a week or longer, the water stored in the plant filter bed so as to send it to the treatment facility located downstream.

The invention consists, apart from the arrangements presented above, of a number of other arrangements, which will be explained in more detail below with regard to an exemplary embodiment described with reference to the appended drawings, although this embodiment is in no way limited. In these drawings:

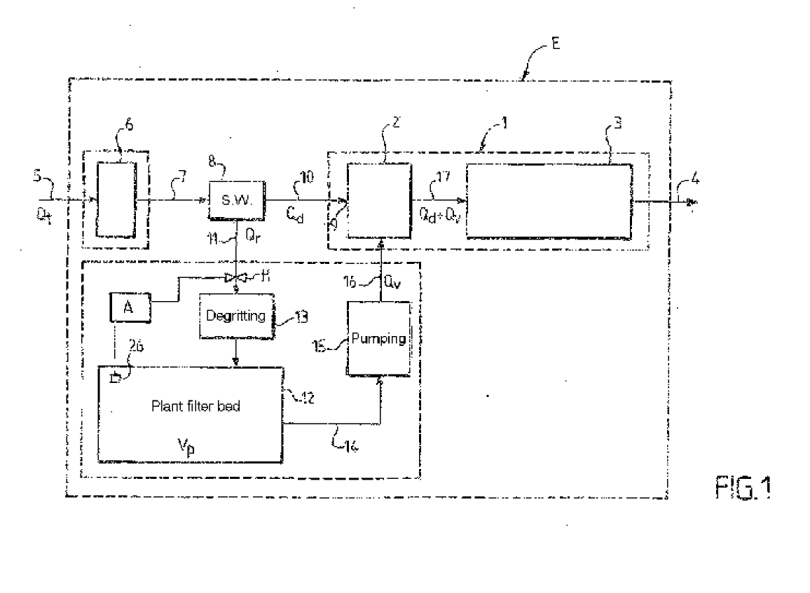

FIG. 1 is a block diagram of a treatment process according to the invention; and

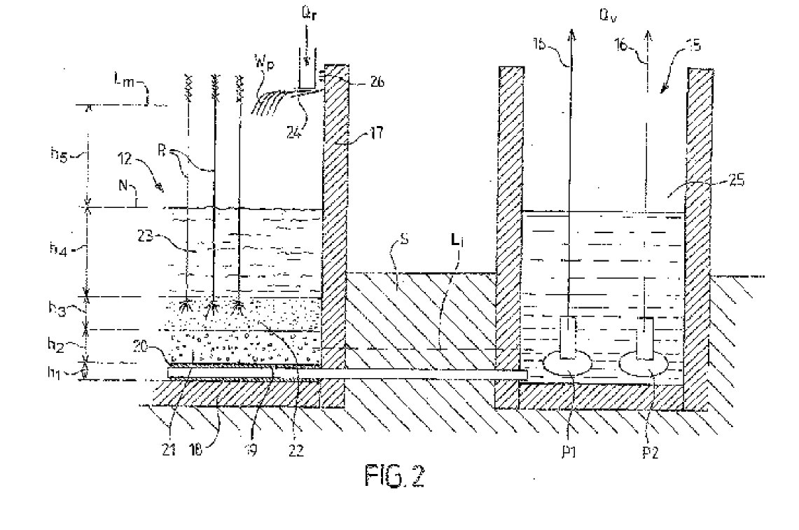

FIG. 2 is a schematic vertical partial section of the treatment installation.

As shown by FIGS. 1 and 2, a treatment installation E according to the invention includes a treatment facility 1 for the effluents of a community provided with a drainage system that drains large quantities of surface water. The system also collects rainwater.

The variations in flow rate between dry weather and rainy weather would result, according to the prior technique, in the treatment facility being designed so that it treats, with relatively constant quality, the large flows of water due to rainwater or stormwater, but these flows are rarely reached in normal service.

According to the invention, the treatment facility 1 has a capacity essentially adapted to the dry weather effluent flow rate. The expression “capacity adapted to the dry weather effluent flow rate” means a capacity which, while still possibly being greater than that strictly needed in dry weather, remains very much smaller than that which would be required to treat, with the same quality, a flow of rainwater or stormwater which may be three or four times greater than the flow rate in dry weather.

The treatment facility 1 may be of the type having a bacterial bed 2 followed by a reed filter bed 3 for final filtration, which gives, as output 4, the treated effluent. The untreated effluent is introduced via the inlet 5 of the installation E. Of course, the treatment facility 1 may be of a type other than that described above, for example of the type using conventional activated sludge, of the membrane biofilter or bio reactor type, or other such means. The treatment facility 1 allows the carbon-containing, or even nitrogen-containing and/or phosphorus-containing pollution to be treated.

The inlet 5 delivers a flow rate Qₜ to a screening device 6, the outlet 7 of which is connected to what is called an SW (storm weir) unit 8. When the incoming effluent flow rate Qₜ is equal to or less than a value Q_{d} corresponding to the dry weather design value, the unit 8 sends all this flow to a line 10 connected to the inlet 9 of the treatment facility 1.

When the untreated effluent flow rate Qₜ is increased by rainwater, the excess Qᵣ relative to Q_{d} is sent via the unit 8 to a line 11 connected to the inlet of a plant filter bed 12 advantageously one based on reeds R, forming a storage and pretreatment basin for the excess effluents collected in rainy weather. Advantageously, a degritter 13 is provided upstream of the filter bed 12. A valve H is installed on the line 11, upstream of the degritter 13.

The outlet 14 of the filter bed 12 is connected to the inlet of a pumping unit 15, and the outlet 16 of which discharges pretreated effluents with a flow rate Qᵥ into the bacterial bed 2 of the treatment facility 1. The outlet 17 of the bacterial bed 2 delivers effluents with a flow rate Q_{d}+Qᵥ to the beds 3 for the final filtration.

FIG. 2 schematically illustrates one embodiment of the filter bed 12 and the pumping unit 15. The filter bed 12 is bounded by vertical walls 17 and a bottom 18, which are for example made of concrete.

Recovery drains 19, sufficiently inclined to the horizontal so as to allow liquid flow-off, are provided near the bottom 18 and pass through the wall 17 toward the pumping unit 15. The height h₁ of a layer 20 containing the drains 19 is of the order of 0.1 m. This layer 20 consists for example of stones of a particle size of 20/40 mm surrounding perforated tubes that constitute the actual drains.

A support layer 21 is provided on top of the layer of drains over a height h₂ of advantageously around 30 cm. This support layer 21 is formed for example from gravel with a particle size of 3/10 mm.

A sand layer 22 is provided on top of the support layer 21. The height h₃ of the sand layer 22 is advantageously about 30 cm, with sand of particle size 0.8/4 mm.

The filtering mass consists of the various abovementioned layers of aggregate of alluvial or siliceous origin (actual sizes: D10/D90).

The sand layer 22 is planted with plants, advantageously reeds R. The vertical walls 17 extend above the upper level of the layer 22 by a sufficient distance so that the storage bed 12 can accept water in rainy weather up to a maximum level Lₘ located at a height h₅, preferably around 0.8 m, above the final measured solid level N. This level N corresponds to the upper surface of a layer of sludge 23. The height h₄ of the layer 23 may be up to about 0.8 m. A weir 24 is provided at the top of the wall 17 in order to distribute the excess rainwater Wᵣ into the storage bed 12.

The particular feature of rainy weather is that it causes an influx of suspended matter, especially fines, at the inlet of the treatment facility because of soil run-off and because of self-flushing of the collectors.

The degritter device 13 provided downstream of the screening device 6 prevents the storage bed 12 from being clogged up with this suspended matter. Taking into account the characteristics of the aggregate provided for the sand layer 22 of the storage bed, the degritter 13 must retain 90% of the sands with a particle diameter greater than 200 μm. The pumping unit 15 transfers the filtrate from the plant bed 12 to the treatment facility 1; the pumping unit 15 consists of a basin 25 fitted with at least one pump P1 and, in the example shown, with two pumps P1 and P2.

Advantageously, the pumps P1 and P2 are of the volumetric type. The pump P1 delivers the liquid into the line 16, which discharges the liquid into the treatment facility 1. The pump P2 is a backup pump which takes over in the event of the pump P1 failing.

The filter bed 12 and the pumping device 15 may be partly buried in the ground S.

The minimum level of liquid Lᵢ corresponds to the minimum level for immersion of the pumps P1 and P2. This level Lᵢ passes substantially through the middle of the support layer 21.

A device 26 for measuring the liquid level in the filter bed 12 is provided. The measurement device 26 is preferably an ultrasonic sensor. On the basis of this liquid level measurement and a programmed clock (not shown), a controller A with an automatic program controls the intake valve H for authorizing the filling of the storage bed 12 or preventing the storage bed 12 from being filled in compliance with predefined rules.

The controller A also controls the solid level N (filtering mass+sludge produced) and monitors it over a long period (over several years) in order to indicate to the operator at what moment the flushing must be carried out. The sludge is then recovered using a double-bucket machine. The minimum liquid level Lᵢ is monitored by detecting the low level in the basin or tank 25 of the pumping unit.

The operation of the installation is as follows.

In dry weather, the total flow rate Qₜ (Qₜ≦Q_{d}) of effluent is sent to the treatment facility 1.

In rainy weather, the total flow rate Qₜ becomes greater than Q_{d}, for example three times greater than Q_{d}. Since the treatment facility 1 is not designed for such a flow, the quality of the treated effluent output at 4 would be greatly impaired if all the flow Qₜ were to be discharged into the treatment facility 1.

According to the invention, the excess Qᵣ due to rain is sent to the filter bed 12, which may be filled up to the level Lₘ.

The storage volume is calculated above the filtering mass 21, 22. This does not take into account the pore volume of the aggregate mass, which represents about 0.2 m³/m² (about 40% porosity). The height of the actual storage volume is therefore equal to about 0.8+0.2=1 m. The height h₄ available for storing the sludge formed is about 0.8 m.

The storage capacity of the bed 12 is generally chosen so as to store the usual rainwater up to the maximum level Lₘ.

Above this, the valve H would be closed and the flow is bypassed, at least partly, into the treatment facility 1.

The rate at which the bed 12 is drained off by the pumping unit 15 is progressive so as not to excessively overload the treatment facility. This drain-off flow rate is chosen so as to drain off the complete stock of the bed 12 over one week (i.e. 7 days). In other words, when the bed 12 is full to the level Lₘ, and in the absence of an influx of further excess water, the pumping unit 15 lowers the liquid from the maximum level Lₘ to the lower level Lᵢ over a week.

The plants, particularly reeds R, are chosen for their capability of withstanding prolonged immersion, and the bed 12 may be fed over a maximum of two weeks. Once the storage capacity has been reached or the feed period is over (maximum of 2 weeks), any new excess water is bypassed by the unit 8 by closing the automatic valve H. The removal period is followed by a rest period of at least one week, needed to prevent stratification of heterogeneous sludge layers.

Thanks to the invention, the treatment facility 1 remains of a size suitable for dry weather effluent flow rates, since the treatment of the excess effluents due to rainwater is spread over several days, preferably at least 7 days.

The bed 12 allows water to be stored in contact with the growing plants, without any fermentation causing foul-smelling pollution being observed.

To illustrate the benefit of the invention as regards the size of the installation, an actual case of a small community in Seine et Marne (France), provided with a not very well sealed drainage system and desirous of treating some (160 m³) of its effluent collected in rainy weather, while still obtaining the same concentration of treated water as in dry weather, is given below in Table 1.

TABLE 1

| | Untreated effluent | | | | Statutory discharge level | | | | | |
|---|---|---|---|---|---|---|---|---|---|---|
| | | | Rainy weather | | Dry | | | | | |
| | Dry weather | | (monthly return) | | weather | | | Rainy weather | | |
| | Stream | Conc. | Stream | Conc. | Stream | Conc. | Eff. | Stream | Conc. | Eff. |
| Flow | 23.4 m³/d | | 183 m³/d | | 23.4 m³/d | | | 183 m³/d | | |
| rate | | | | | | | | | | |
| Max. | 3.9 m³/h | | 349 m³/h | | 3.9 m³/h | | | 46 m³/h | | |
| flow | | | | | | | | | | |
| rate | | | | | | | | | | |
| BOD₅ | 9.4 kg/d | 400 mg/l | 14.0 kg/d | 77 mg/l | 0.6 kg/d | 25 mg/l | 94% | 4.6 kg/l | 25 mg/l | 67% |
| COD | 23.4 kg/d | 1000 mg/l | 35.1 kg/d | 191 mg/l | 2.9 kg/d | 125 mg/l | 88% | 22.9 kg/d | 125 mg/l | 35% |
| SM | 14.0 kg/d | 600 mg/l | 28.1 kg/d | 153 mg/l | 0.8 kg/d | 35 mg/l | 94% | 6.4 kg/d | 35 mg/l | 77% |
| NK | 2.3 kg/d | 100 mg/l | 2.8 kg/d | 15 mg/l | | | | | | |
| PT | 0.6 kg/d | 26 mg/l | 0.7 kg/d | 4 mg/l | | | | | | |

From a hydraulic standpoint, the pollution produced by this community may be translated into equivalent inhabitants (base=150 l/EI/d) as follows:
dry weather: 156 EI (i.e. 23400/150);
rainy weather: 1220 EI (i.e. 183000/150.

In the case of the above effluent treatments with a bacterial-bed treatment facility 1, with an ordered plastic lining and Hamon Crosspack™ modular blocks, to obtain the statutory discharge level with a facility 1 alone in dry weather (“dry weather” column) and in rainy weather (“rainy weather” column) with a monthly return frequency, and with an installation according to the invention (facility 1+bed 12) requires dimensions given in Table 2 below.

TABLE 2

| | | | Facility 1 alone | | |
|---|---|---|---|---|---|
| | | | Dry | Rainy | Facility 1 + |
| | | | weather | weather | bed 12 |
| | Degritting | m² | — | — | 7 |
| | area | | | | |
| | Storage | m² | — | — | 200 |
| | area | | | | |
| Bacterial | Packing | m³ | 21 | 376 | 21 |
| bed | volume | | | | |
| | Height | m | 2.66 | 2.66 | 2.66 |
| | Horizontal | m² | 8 | 140 | 8 |
| | surface | | | | |
| | Feed rate | m³/h | 19 | 349 | 19 |
| Final | Area | m² | 92 | 460 | 120 |
| filtration | | | | | |
| Total | Area | m² | 100 | 600 | 335 |

For the same treated pollution and the same treated water quality, thanks to the invention, the footprint of the treatment facility is reduced by a factor of 1.8 (i.e. 600/335). The volume of the bacterial bed, designed for dry weather, does not vary, thereby greatly reducing the total cost of the treatment facility.

In this design example, the various hydraulic volumes flowing through the installation are given in Table 3 below.

TABLE 3

| | | | | Full | Non-drained |
|---|---|---|---|---|---|
| | | Dry | Rainwater | storage^{a} | storage^{c} |
| | | weather | storage D1 | D1 + n | D1 + [n < 14d] |
| Qₜ | m³/j | 23.4 | 183 | >23.4 | 33.4^{d} |
| Qₑ | | 0 | 0 | >0 | 0 |
| | | | | (bypass) | |
| Q_{d} | | 23.4 | 23.4 | 23.4 | 23.4 |
| Qᵣ | | 0 | 160 | 0 | 10 |
| Qᵥ | | 0 | 160/7 = 22.9^{b} | 22.9 | 22.9 |
| Vₚ | m³ | 0 | 0 | 160 | 150 |
| (initial) | | | | | |
| Vₚ | m³ | 0 | 160 | 160 | 160^{c} |
| (final) | | | | | |

Qₑdenotes the bypassed flow rate;
^{a}assumption: the planned storage capacity is reached (here 160 m³), but it rains;
^{b}assumption: drained over 7 days (24 h/24);
^{c}by assumption, the storage bed is already filled with 150 m³ of water from a previous rainy period (and is in the course of being drained).
^{d}indicative example;
^{e}if the storage capacity is again reached, then Qₑ > 0.

However, it is possible to again store further rainy weather effluent, to the height of the available capacity, if this new filling is carried out less than 2 weeks after the end of the last rest period.

After 14 days of filling and draining, the filling can no longer be carried out and the draining is progressively terminated. Once the latter has been completed, there is a 2-week rest period (no water feed).

The columns of Table 3 are analyzed as follows.

1. The “dry weather” column indicates, on the Qₜ row the flow rate of untreated effluent entering the inlet 5 of the installation. During dry weather, this flow rate Qₜ is equal to Q_{d}=23.4 m³/d in the example in question.

The flow rate Qₑ of bypassed effluent is zero, as is the rainwater flow rate Qᵣ, and therefore also the flow rate Qᵥ of effluent discharged by the pumping unit 15.

“Initial Vₚ” corresponds to the initial volume of water stored in the bed 12, which is zero. Likewise, the “final Vₚ” volume remains zero, since the weather is dry.

2. The “rainwater storage D1” column corresponds to a day in which a 160 m³ volume of rainwater is collected in the filter bed 12.

The total flow rate Qₜ=Q_{d}+Qᵣ=183.4 m³/day rounded to 183 m³/day.

Since the 160 m³ of the bed 12 is designed to be drained off over 7 days, the drain-off flow rate Qᵥ=160/7=22.9 m³/d. The initial volume Vₚ in the bed 12 was assumed to be equal to 0 and the final volume Vₚ is equal to 160 m³.

3. The third, “full storage D1+n” column corresponds to the full bed 12 (Vₚ=160 m³) although rain falls. The incoming flow rate Qₜ is therefore greater than the flow rate Q_{d}=23.4 m³/d. The excess relative to Q_{d} cannot be sent to the full filter bed 12 and is bypassed.

4. The fourth column corresponds to the case in which the storage bed 12 is not completely filled without however being completely emptied. The storage bed 12 is assumed to be filled with 150 m³ of effluent from a previous period and is in the course of being drained off.

However, it is possible to store a new effluent in rainy weather to a height of the available capacity if this new filling is carried out less than 14 days (2 weeks) after the end of the last rest period.

When the storage capacity is again reached, the flow is bypassed.

For example, considering the case of slight rain, Qᵣ=10 m³/day, which can be added to the dry weather flow rate of 23.4 m³/day to give a total flow rate Qₜ of 33.4 m³/day.

Beyond 14 days of filling and draining after the end of the last rest period, the bed 12 can no longer be filled and the excess is bypassed, while the draining operation is progressively completed. Once this has been completed, there are two weeks of rest, with no water fed into the bed 12.

1. An effluent treatment process for communities equipped with a drainage system capable of collecting rainwater or infiltration water, so that the flow rates of effluents to be treated by a treatment facility may vary greatly between a dry weather period and a rainy period, characterized in that:
a treatment facility (1) is provided with a capacity essentially adapted to the dry weather effluent flow rate (Q_{d});
provided upstream of the treatment facility is a plant filter bed (12) suitable for storing, without fermentation, an excess of polluted water and in carrying out a pretreatment;
the excess flow of effluents (Qᵣ) caused by rainwater or stormwater is directed onto the plant filter bed (12); and
the water stored in the plant filter bed (12) is drained off over several days so as to send it to the treatment facility (1) located downstream, in order to avoid oversizing the treatment facility (1).

2. The process as claimed in claim 1, wherein the water stored in the filter bed (12) is drained off over a week, or longer.

3. The process as claimed in claim 1, wherein the treatment facility (1) is sized for a dry weather effluent flow rate.

4. The process as claimed in claim 1, wherein the period for removing the wastewater from the plant bed is followed by a rest period of at least one week, in order to prevent stratification of heterogeneous sludge layers.

5. The process as claimed in claim 1, wherein the storage tank is fed over a period of at least two weeks, the plants having to be capable of withstanding prolonged immersion.

6. The process as claimed in claim 1, wherein a bypass (8, H) is provided for directing the effluent flow to the treatment facility when the storage capacity of the plant bed filter (12) is reached or when the feed period is over.

7. The process as claimed in claim 1, wherein a controller (A) with an automatic program controls a valve (H) for the intake of effluents into the plant filter bed (12) on the basis of the measurement (26) of the liquid level in the reed filter and on the basis of a programmed clock.

8. The process as claimed in claim 7, wherein the automatic program is designed to control the level of solids (filter mass plus sludge produced) and to monitor it over a long period (several years) in order to indicate at what moment a flushing operation has to be carried out.

9. The process as claimed in claim 1, wherein the plants are reeds (R).

10. An effluent treatment installation for communities equipped with a drainage system capable of collecting rainwater or infiltration water, for implementing the process defined above, characterized in that it comprises:
a treatment facility (1) of capacity adapted essentially to the dry weather effluent flow rate (Q_{d});
upstream of the treatment facility, a plant filter bed (12) suitable for storing, without fermentation, an excess flow of polluted water and in carrying out a pretreatment;
means (11, 24) for directing the excess flow of effluents caused by rainwater or stormwater onto the plant filter bed (12); and
means (15) for draining off, over several days, in particular a week or longer, the water stored in the plant filter bed (12) so as to send it to the treatment facility (1) located downstream.

11. The effluent treatment installation as claimed in claim 10, wherein it includes a degritting device (13) upstream of the filter bed (12).

12. The effluent treatment installation as claimed in claim 10, wherein the outlet (14) of the filter bed (12) is connected to the inlet of a pumping unit (15), the outlet (16) of which discharges a pretreated effluent flow into the treatment facility (1).

13. The effluent treatment installation as claimed in claim 10, wherein the filter bed includes recovery drains (19), provided near the bottom (18) and passing through a wall (17) into a pumping unit (15), a support layer (21) formed from gravel is provided on top of the drains (19) over a height h₂, and a sand layer (22) is then provided on top of the support layer (21).

14. The effluent treatment installation as claimed in claim 10, wherein the plants of the filter bed are reeds (R).
